(19) United States
(12) Patent Application Publication
(10) Pub. No.: US 2025/0234090 A1
(43) Pub. Date: Jul. 17, 2025

(54) LENS APPARATUS, IMAGE PICKUP APPARATUS, CONTROL METHOD, AND STORAGE MEDIUM

(71) Applicant: CANON KABUSHIKI KAISHA, Tokyo (JP)

(72) Inventor: KAZUYA SHIMOMURA, Saitama (JP)

(21) Appl. No.: 18/981,909

(22) Filed: Dec. 16, 2024

(30) Foreign Application Priority Data
Jan. 16, 2024 (JP) 2024-004407

(51) Int. Cl. H04N 23/667; H04N 23/67; H04N 23/69

(52) U.S. Cl. CPC H04N 23/667; H04N 23/67; H04N 23/69

(57) ABSTRACT

A lens apparatus is attachable to and detachable from an image pickup apparatus. The lens apparatus includes a zoom lens including a focus lens configured to move for focusing, and a magnification varying lens configured to move for magnification variation, and a processor configured to perform a lens angle-of-view correction processing for driving the magnification varying lens to reduce an angle-of-view change of the zoom lens associated with movement of the focus lens, and change the lens angle-of-view correction processing according to whether or not an aberration correction processing for reducing an aberration of the zoom lens is performed for image data in the image pickup apparatus.

### BACKGROUND

### Technical Field

The present disclosure relates to a lens apparatus having a zoom lens.

### Description of Related Art

Some zoom lenses for image pickup apparatuses such as video cameras may experience an angle-of-view change (breathing) associated with focusing. This angle-of-view change is caused by changes in imaging magnification and distortion due to movement of a focus lens, and is noticeable particularly in moving image capturing.

Japanese Patent Laid-Open No. 2000-171679 discloses a lens apparatus that cancels an angle-of-view change by moving a magnification varying lens in accordance with movement of a focus lens. Japanese Patent Laid-Open No. 2019-208168 discloses an image pickup apparatus that changes a magnification varying ratio of captured image data in accordance with a relationship between correction data for correcting an angle-of-view change associated with focusing and correction data for correcting distortion.

### SUMMARY

According to some embodiments of the present disclosure, a lens apparatus is attachable to and detachable from an image pickup apparatus. The lens apparatus includes a zoom lens including a focus lens configured to move for focusing, and a magnification varying lens configured to move for magnification variation, and a processor configured to perform a lens angle-of-view correction processing for driving the magnification varying lens to reduce an angle-of-view change of the zoom lens associated with movement of the focus lens, and change the lens angle-of-view correction processing according to whether or not an aberration correction processing for reducing an aberration of the zoom lens is performed for image data in the image pickup apparatus. An image pickup apparatus to which the above lens apparatus is detachably attachable, and in which the aberration correction processing can be set to be enabled or disabled also constitutes another aspect of the disclosure. A control method corresponding to the above lens apparatus also constitutes another aspect of the disclosure. A storage medium storing a program that causes a computer to execute the above control method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram illustrating the configuration of an imaging system including a lens apparatus according to Example 1.

FIG. 2 is a flowchart illustrating processing according to Example 1.

FIGS. 3A to 3D explain electronic distortion correction according to Example 1.

FIG. 4 is a block diagram illustrating the configuration of an imaging system including a lens apparatus according to Example 2.

FIG. 5 is a flowchart illustrating processing according to Example 3.

FIG. 6 is a block diagram illustrating the configuration of an imaging system including a lens apparatus according to Example 4.

FIG. 7 is a flowchart illustrating processing according to Example 4.

FIG. 8 is a block diagram illustrating the configuration of an imaging system including a lens apparatus according to Example 5.

FIG. 9 is a flowchart illustrating processing according to Example 5.

FIG. 10 is a block diagram illustrating the configuration of an imaging system including a lens apparatus according to Example 6.

FIG. 11 is a flowchart illustrating processing according to Example 6.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of examples according to the disclosure. In each example, a case will be described in which an interchangeable lens as a lens apparatus is detachably attached to an image pickup apparatus such as a digital camera. The interchangeable lens according to each example has a zoom lens as an imaging optical system, and the zoom lens changes an angle of view associated with focusing (referred to as a focus angle-of-view change hereinafter).

### Example 1

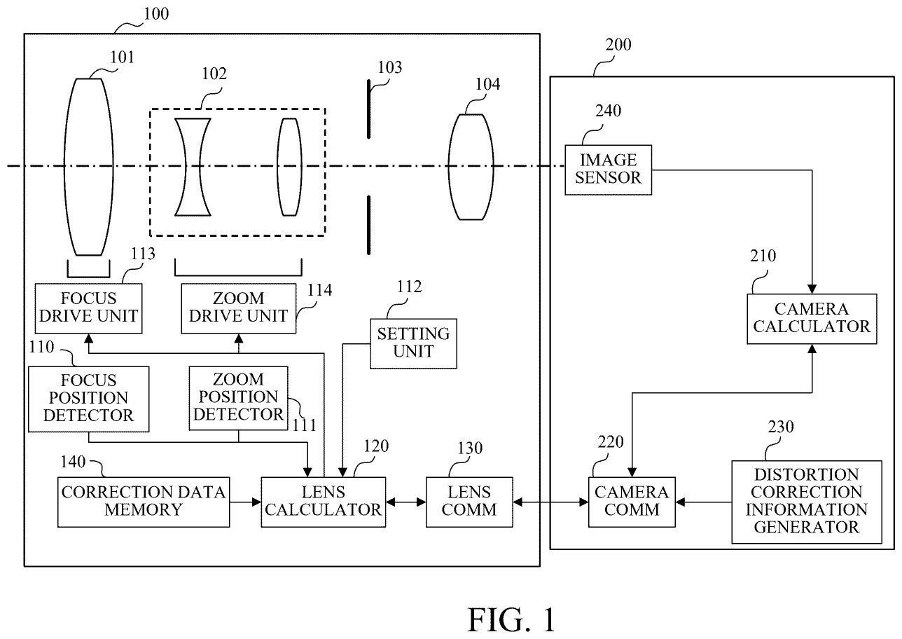

FIG. 1 illustrates an imaging system that includes an interchangeable lens 100 and a digital camera 200 according to Example 1.

In the interchangeable lens 100, the zoom lens has a focus lens unit 101 configured to move for focusing, a magnification varying lens unit 102 configured to move for magnification variation (zooming), an aperture stop 103 with a variable aperture diameter, and a relay lens unit 104 for imaging. The lens unit is a group of one or more lenses that integrally move during zooming and focusing, and a distance between adjacent lens units changes during zooming and focusing. The lens that moves for focusing (focus sub lens unit) may be a part of the lens unit closest to an object.

The zoom lens according to this example is a front focus type zoom lens in which the focus lens unit 101 is disposed closest to an object. However, the zoom lens may be an inner focus (rear focus) type in which the focus lens unit is disposed on the image side of the lens unit closest to the object. The magnification varying lens unit 102 may include a plurality of lens units whose distance changes during zooming.

The position of the focus lens unit 101 is detected by a focus position detector 110. The position of the magnification varying lens unit 102 is detected by a zoom position detector 111. A setting unit 112 sets whether or not to correct a focus angle-of-view change. Each of a focus drive unit 113 and a zoom drive unit 114 includes an actuator such as a motor that drives the focus lens unit 101 or the magnification varying lens unit 102.

A lens calculator 120 as a processing unit includes a computer such as a CPU, etc., and performs various processing within the interchangeable lens 100. A lens communication unit 130 transmits and receives information to and from the digital camera 200. A correction data memory 140 includes a nonvolatile memory or the like, and stores correction data for reducing (correcting) a focus angle-of-view change. The correction data is data indicating the position to which the magnification varying lens unit 102 is moved in order to correct a focus angle-of-view change caused by the movement (position change) of the focus lens unit 101.

In the digital camera 200, the camera calculator 210 includes a computer including a CPU and performs various processing within the digital camera 200. A communication unit 220 communicates information with the camera interchangeable lens 100. A distortion correction information generator 230 generates information indicating whether the distortion correction processing in the digital camera 200 is enabled (turned on) or disabled (turned off). The distortion correction processing is enabled or disabled by a user's operation on the digital camera 200.

An image sensor 240 is a photoelectric conversion element such as a CCD sensor or a CMOS sensor that photoelectrically converts an object image formed by the zoom lens. The camera calculator 210 performs various image processing for an electric signal (imaging signal) from the image sensor 240 to generate a captured image (image data). In a case where the distortion correction processing is enabled, the camera calculator 210 performs distortion correction processing (aberration correction processing) for the image data as image processing for reducing (correcting) the distortion of the zoom lens included in the image data.

In this example, the digital camera 200 can performing aberration correction processing to correct distortion in image data, but the aberration correction processing performed by the digital camera may be processing to correct aberrations other than distortion.

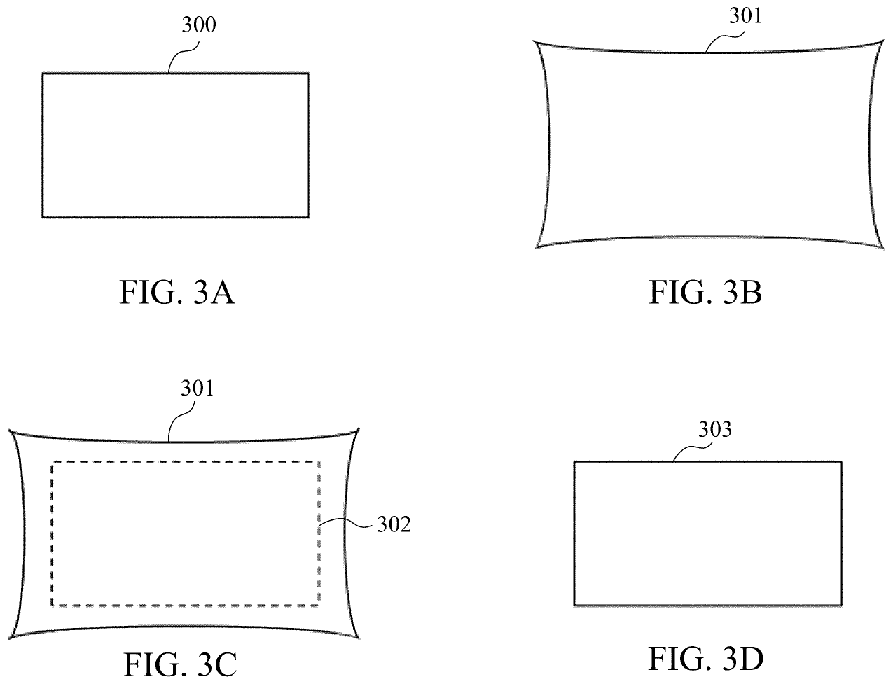

The distortion correction processing will be described with reference to FIGS. 3A to 3D. FIG. 3A illustrates image data 300 before the distortion correction processing is performed, and this image data includes barrel distortion. The distortion correction processing to the image data 300 cancels a distortion component for each image height. More specifically, the image data 300 receives magnification varying processing with a different magnification varying ratio for each image height (enlargement processing for barrel distortion). FIG. 3B illustrates image data 301 after the distortion correction processing is performed. Distortion correction processing on the positive side is performed for barrel distortion, and as a result, the number of pixels constituting the image data increases.

Next, in order to generate image data with the same pixel size as that before distortion correction, an area 302 with the same number of pixels as that before the distortion correction processing is cut out (cropped) from the image data 301 after the distortion correction processing is performed, as illustrated in FIG. 3C. As a result, image data 303 corresponding to the area 302 with the same pixel size as that of the image data 300 before the distortion correction processing is performed is finally generated as illustrated in FIG. 3D. In this case, an angle of view corresponding to the image data 303 after the distortion correction processing is performed is narrower than an angle of view corresponding to the image data 300 before the distortion correction processing is performed. In other words, an angle of view changes according to whether distortion correction processing is enabled or disabled.

Therefore, this example changes the lens angle-of-view correction processing (a position and drive amount for driving the magnification varying lens unit 102) that drives the magnification varying lens unit 102 to correct the focus angle-of-view change according to whether distortion correction processing is enabled or disabled. More specifically, this example changes the lens angle-of-view correction processing by changing the correction data that is used in the lens angle-of-view correction processing according to whether the distortion correction processing is enabled or disabled.

In a case where the lens angle-of-view correction processing is performed without using correction data, the lens angle-of-view correction processing may be changed without changing the correction data according to whether the distortion correction processing is enabled or disabled.

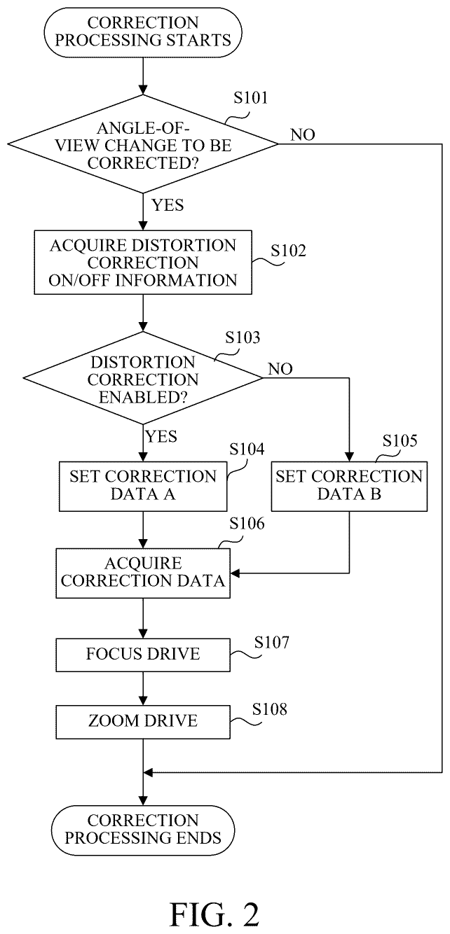

FIG. 2 illustrates the lens angle-of-view correction processing (control method) performed by the lens calculator 120 according to this example. The lens calculator 120 executes this processing according to a program.

In step S101, the lens calculator 120 acquires from the setting unit 112 a determination result of whether or not to correct a focus angle-of-view change. In a case where the focus angle-of-view change is to be corrected, the flow proceeds to step S102, and in a case where the focus angle-of-view change is not to be corrected, this flow ends.

In step S102, the lens calculator 120 acquires the enablement or disablement of the distortion correction processing in the digital camera 200 from the distortion correction information generator 230.

In step S103, the lens calculator 120 determines whether distortion correction processing in the digital camera 200 is enabled or disabled, and in a case where it is enabled, the flow proceeds to step S104, and in a case where it is disabled, the flow proceeds to step S105.

In step S104, the lens calculator 120 sets the correction data for correcting the focus angle-of-view change to correction data A to be used in a case where distortion correction processing is enabled. Then, the flow proceeds to step S106.

In step S105, the lens calculator 120 sets the correction data for correcting the focus angle-of-view change to correction data B to be used in a case where distortion correction processing is disabled. Then, the flow proceeds to step S106.

In step S106, the lens calculator 120 reads the correction data A or B set in step S104 or S105 from the correction data memory 140.

In step S107, in a case where the focus lens unit 101 is driven, the lens calculator 120 calculates a drive amount of the magnification varying lens unit 102 from the position of the focus lens unit 101 and the correction data A or B.

Next, in step S108, the lens calculator 120 drives the magnification varying lens unit 102 according to the drive amount calculated in step S107. Thereby, the focus angle-of-view change is corrected.

As described above, this example switches the correction data that is used to correct a focus angle-of-view change according to whether or not distortion correction processing is performed in the digital camera 200. Thereby, the focus angle-of-view change can be satisfactorily corrected regardless of whether or not distortion correction processing is performed.

### Example 2

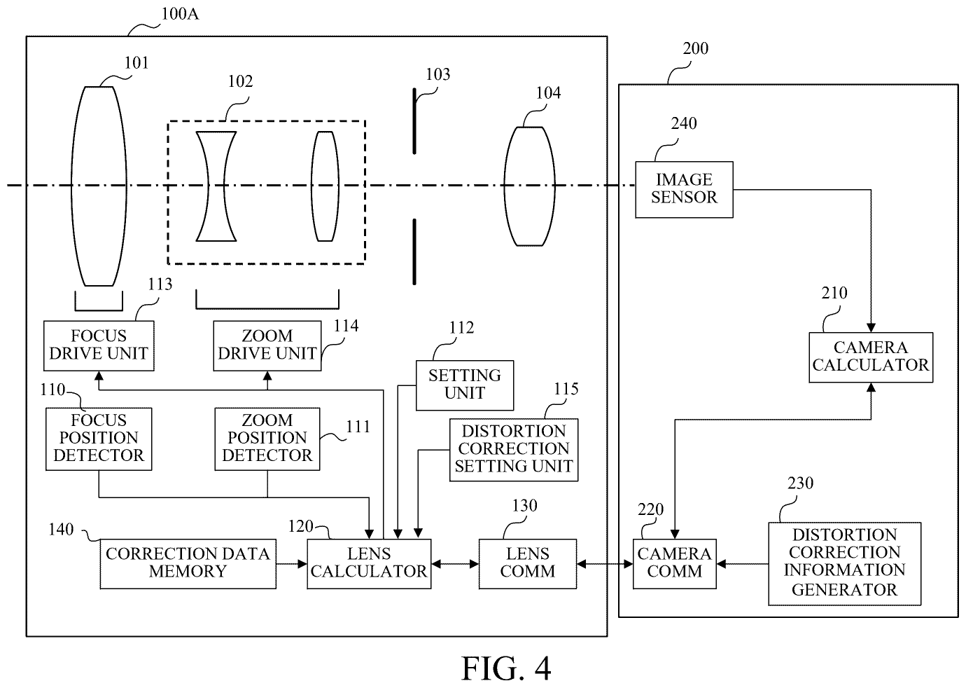

Next, Example 2 will be described. FIG. 4 illustrates the configuration of an imaging system including an interchangeable lens 100A and a digital camera 200. This example is different from Example 1 in that the interchangeable lens 100A has a distortion correction setting unit 115. The distortion correction setting unit 115 sets the enablement or disablement of distortion correction processing for the digital camera 200 according to a user's operation on the interchangeable lens 100A.

The lens angle-of-view correction processing in this example is the same as that in Example 1 (FIG. 2).

This example also switches the correction data that is used to correct a focus angle-of-view change according to whether or not the distortion correction processing is performed in the digital camera 200. Thereby, the focus angle-of-view change can be satisfactorily corrected regardless of whether or not the distortion correction processing is performed.

### Example 3

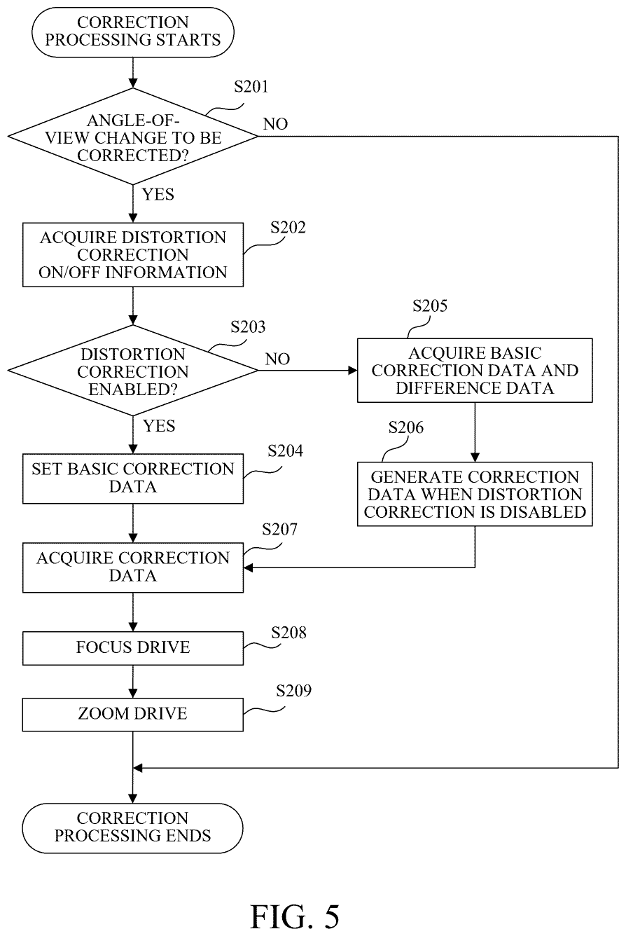

Next, Example 3 will be described. The configuration of the imaging system according to this example is the same as that in Example 1 (FIG. 1), but the lens angle-of-view correction processing is different from that in Example 1 (FIG. 2), as illustrated in the flowchart in FIG. 5.

In this example, the correction data memory 140 stores basic correction data (first data) as correction data for driving the magnification varying lens unit 102 to correct a focus angle-of-view change. The basic correction data corresponds to the correction data A that is used in a case where the distortion correction processing described in Example 1 is enabled. The correction data memory 140 also stores difference data (second data) that is combined with the basic correction data to generate correction data (corresponding to the correction data B in Example 1) that is used in a case where the distortion correction processing is disabled.

Both the basic correction data and the difference data are configured as two-dimensional table data corresponding to the positions of the focus lens unit 101 and the magnification varying lens unit 102. In this example, the number of positions of the focus lens unit 101 and the magnification varying lens unit 102 that store differences in the difference data is set to be smaller than that of the basic correction data. In other words, the data capacity of the difference data is smaller than that of the basic correction data. Therefore, the data capacity of the correction data memory 140 can be smaller than that in storing the correction data A and B corresponding to the enablement and disablement of the distortion correction processing in the correction data memory 140 as in Example 1.

Steps S201 to S203 in FIG. 5 are similar to steps S101 to S103 in FIG. 1.

In step S203, the lens calculator 120 determines whether the distortion correction processing in the digital camera 200 is enabled or disabled, and in a case where it is enabled, the flow proceeds to step S204, and in a case where it is disabled, the flow proceeds to step S205.

In step S204, the lens calculator 120 sets correction data for correcting a focus angle-of-view change as basic correction data. The flow then proceeds to step S207, and the lens calculator 122 reads the basic correction data from the correction data memory 140. Next, the flow proceeds to step S208.

In step S205, the lens calculator 120 reads the basic correction data and difference data from the correction data memory 140.

Next, in step S206, the lens calculator 120 combines the read basic correction data and difference data, more specifically adds the difference data to the basic correction data, to generate correction data (referred to as added correction data hereinafter) to be used in a case where the distortion correction processing is disabled. The flow then proceeds to step S207, and the lens calculator 120 reads the added correction data. Then, the flow proceeds to step S208.

In step S208, in a case where the focus lens unit 101 is driven, the lens calculator 120 calculates a drive amount of the magnification varying lens unit 102 using the position of the focus lens unit 101 and the basic correction data or added correction data read in step S207.

In step S209, the lens calculator 120 drives the magnification varying lens unit 102 in accordance with the drive amount calculated in step S208. This corrects the change in the focus angle of view.

This example switches the correction data for correcting a focus angle-of-view change according to whether or not the distortion correction processing is performed in the digital camera 200. Thereby, the focus angle-of-view change can be satisfactorily corrected regardless of whether or not the distortion correction processing is performed. This example combines the basic correction data and the difference data and generates the added correction data that is used in a case where the distortion correction processing is disabled. Thereby, the data capacity stored in the correction data memory 140 can be reduced.

In this example, the basic correction data is used as the correction data in a case where the distortion correction processing is enabled, but the basic correction data may be used as the correction data in a case where the distortion correction processing is disabled. In this case, the correction data that is used in a case where the distortion correction processing is enabled is generated by combining the basic correction data and the difference data.

The correction data A may be generated by combining the basic correction data for the correction data A and the difference data. In this case, the data capacity of the difference data may be smaller than that of the basic correction data.

### Example 4

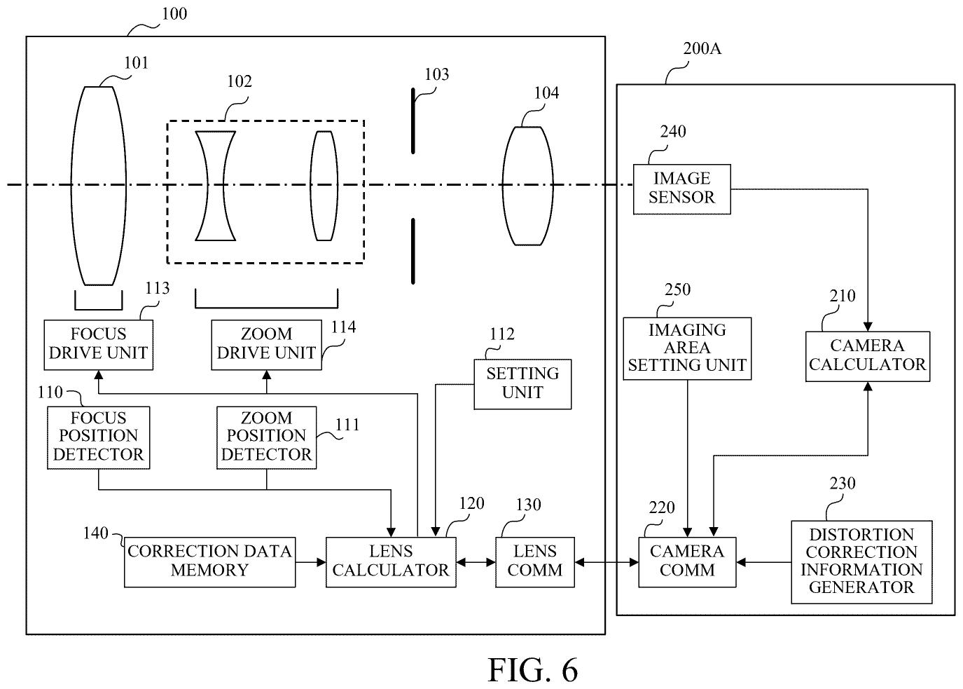

Next, Example 4 will be described. FIG. 6 illustrates the configuration of an imaging system including the interchangeable lens 100 and a digital camera 200A. This example is different from Example 1 in that the digital camera 200A includes an imaging area setting unit 250. The imaging area setting unit 250 sets the imaging area. The imaging area is an area on the imaging surface of the image sensor 240 that has different sizes, such as an area equivalent to 35 mm full size or an area equivalent to Advanced Photo System type C (APS-C). The imaging area is set according to the user's operation to the digital camera 200A.

In a case where the zoom lens has pincushion distortion, the correction is on the negative side, and the number of pixels constituting the image data is reduced. In order to ultimately output image data with the same pixel size as that before the distortion correction processing is performed, processing for enlarging the image data after the distortion correction processing is performed is performed to equalize the number of pixels to that before the distortion correction processing is performed. An enlargement ratio at this time differs according to the imaging area. Hence, this example changes the correction data for correcting the focus angle-of-view change according to the imaging area.

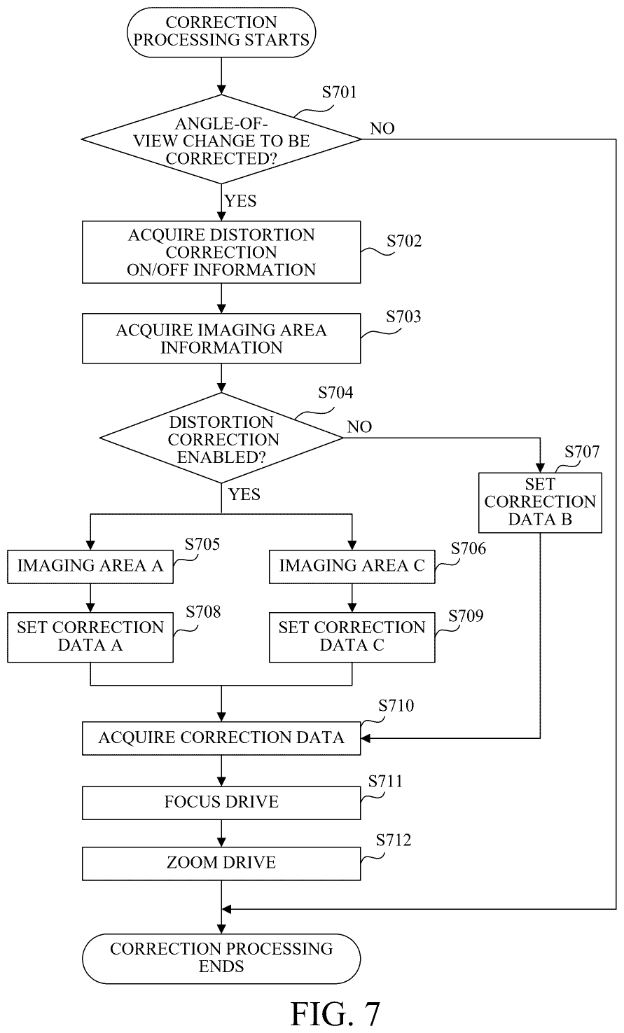

FIG. 7 illustrates lens angle-of-view correction processing executed by the lens calculator 120 according to this example. Steps S701 and S702 in FIG. 7 are similar to steps S101 and S102 in FIG. 1.

In step S703, the lens calculator 120 acquires information about the set imaging area from the imaging area setting unit 250.

In step S704, the lens calculator 120 determines whether distortion correction processing in the digital camera 200 is enabled or disabled, and determines the imaging area. In a case where distortion correction processing is enabled and the imaging area is an imaging area A equivalent to 35 mm full size, the flow proceeds to step S705, and in a case where it is an imaging area C equivalent to APS-C, the flow proceeds to step S706. On the other hand, in a case where distortion correction processing is disabled, the flow proceeds to step S707.

In step S708, which is the next step of step S705, the lens calculator 120 sets correction data for correcting the focus angle-of-view change to the correction data A corresponding to the imaging area A, and the flow proceeds to step S710.

In step S709, which is the next step of step S706, the lens calculator 120 sets the correction data to the correction data C corresponding to the imaging area C, and the flow proceeds to step S710.

In step S707, the lens calculator 120 sets the correction data for correcting the focus angle-of-view change to the correction data B, and the flow proceeds to step S710.

In step S710, the lens calculator 120 reads the correction data A, C, or B set in step S708, S709, or S707 from the correction data memory 140.

In step S711, in a case where the focus lens unit 101 is driven, the lens calculator 120 calculates a drive amount of the magnification varying lens unit 102 from the position of the focus lens unit 101 and the correction data A, B, or C.

Next, in step S712, the lens calculator 120 drives the magnification varying lens unit 102 in accordance with the drive amount calculated in step S711. Thereby, the focus angle-of-view change can be corrected.

This example switches the correction data that is used to correct the focus angle-of-view change according to whether distortion correction processing is performed in the digital camera 200 and the imaging area. Thereby, the focus angle-of-view change can be satisfactorily corrected regardless of the imaging area and whether distortion correction processing is performed.

### Example 5

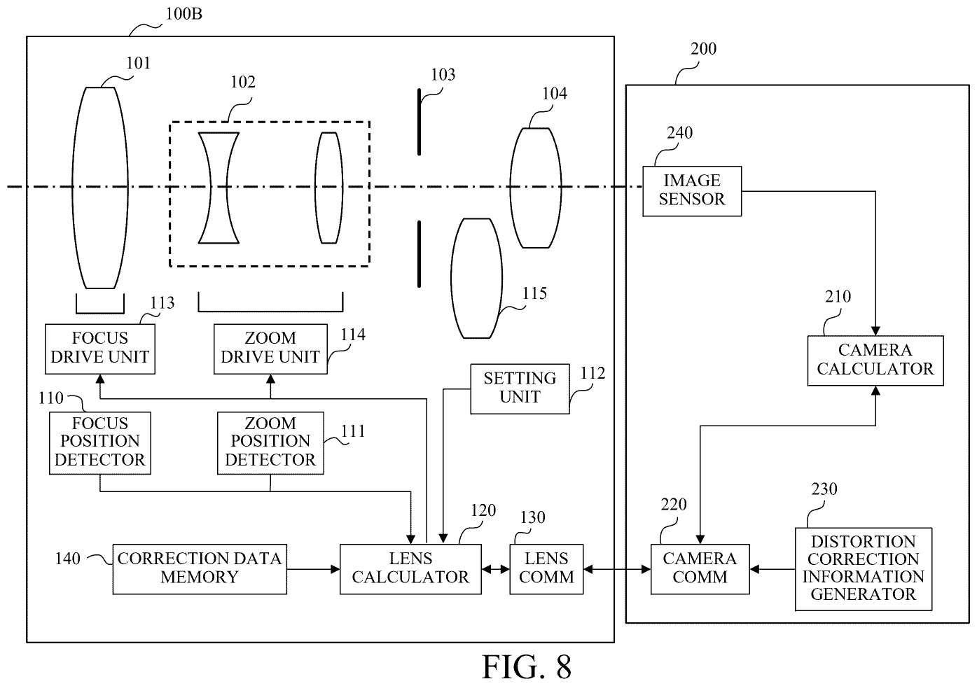

Next, Example 5 will be described. FIG. 8 illustrates the configuration of an imaging system including an interchangeable lens 100B and the digital camera 200. This example is different from Example 1 in that the interchangeable lens 100B can shift a focal length range of the zoom lens by inserting and ejecting an extender unit 105 as an optical unit into and from an optical axis of the zoom lens (relay lens unit 104).

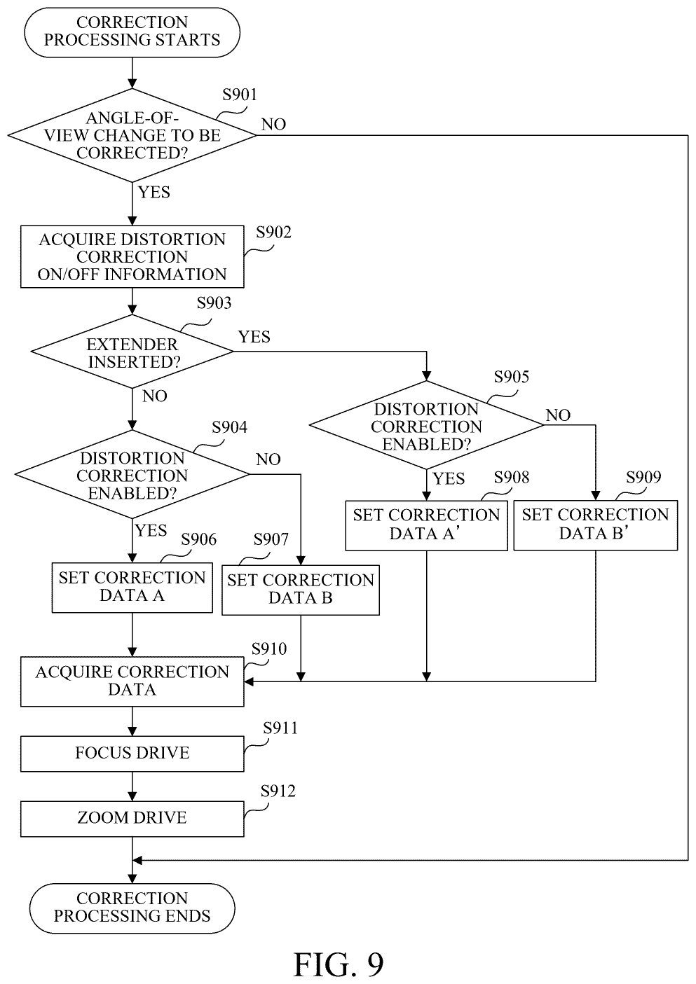

FIG. 9 illustrates lens angle-of-view correction processing executed by the lens calculator 120 according to this example. Steps S901 and S902 in FIG. 9 are similar to steps S101 and S102 in FIG. 1.

In step S903, the lens calculator 120 determines whether or not the extender unit 105 is inserted into an optical axis of the zoom lens. If not, the flow proceeds to step S904. If inserted, the flow proceeds to step S905.

In step S904, the lens calculator 120 determines whether the distortion correction processing in the digital camera 200 is enabled or disabled. In a case where enabled, the flow proceeds to step S906. In a case where it is disabled, the flow proceeds to step S907.

In step S906, the lens calculator 120 sets the correction data for correcting a focus angle-of-view change to correction data A, which is used in a case where the extender unit 105 is not inserted and the distortion correction processing is enabled. Then, the flow proceeds to step S910.

In step S907, the lens calculator 120 sets the correction data for correcting a focus angle-of-view change to correction data B, which is used in a case where the extender unit 105 is not inserted and the distortion correction processing is disabled. Then, the flow proceeds to step S910.

On the other hand, in step S905, the lens calculator 120 determines whether distortion correction processing in the digital camera 200 is enabled or disabled. If it is enabled, the flow proceeds to step S908, and if it is disabled, the flow proceeds to step S909.

In step S906, the lens calculator 120 sets the correction data for correcting the focus angle-of-view change to correction data A′, which is used in a case where the extender unit 105 is inserted and distortion correction processing is enabled. Then, the flow proceeds to step S910.

In step S907, the lens calculator 120 sets the correction data for correcting the focus angle-of-view change to correction data B′, which is used in a case where the extender unit 105 is inserted and distortion correction processing is disabled. Then, the flow proceeds to step S910.

Instead of the correction data A′ and B′, difference data indicating the difference from the correction data A and B as basic correction data may be used, or the correction data B may also be difference data from the correction data A as basic correction data.

In step S910, the lens calculator 120 reads from the correction data memory 140 one of the correction data A, B, A′, and B′ set in steps S906 to S909.

In step S911, the lens calculator 120 calculates a drive amount of the magnification varying lens unit 102 using the position of the focus lens unit 101 and the correction data read in step S910 in a case where the focus lens unit 101 is driven.

Next, in step S912, the lens calculator 120 drives the magnification varying lens unit 102 according to the drive amount calculated in step S911. Thereby, the focus angle-of-view change can be corrected.

This example switches the correction data for correcting the focus angle-of-view change according to whether distortion correction processing is performed in the digital camera 200 and whether the extender unit 105 is inserted or ejected. Thereby, the focus angle-of-view change can be satisfactorily corrected regardless of whether distortion correction processing is performed or not and whether the extender unit 105 is inserted or ejected.

### Example 6

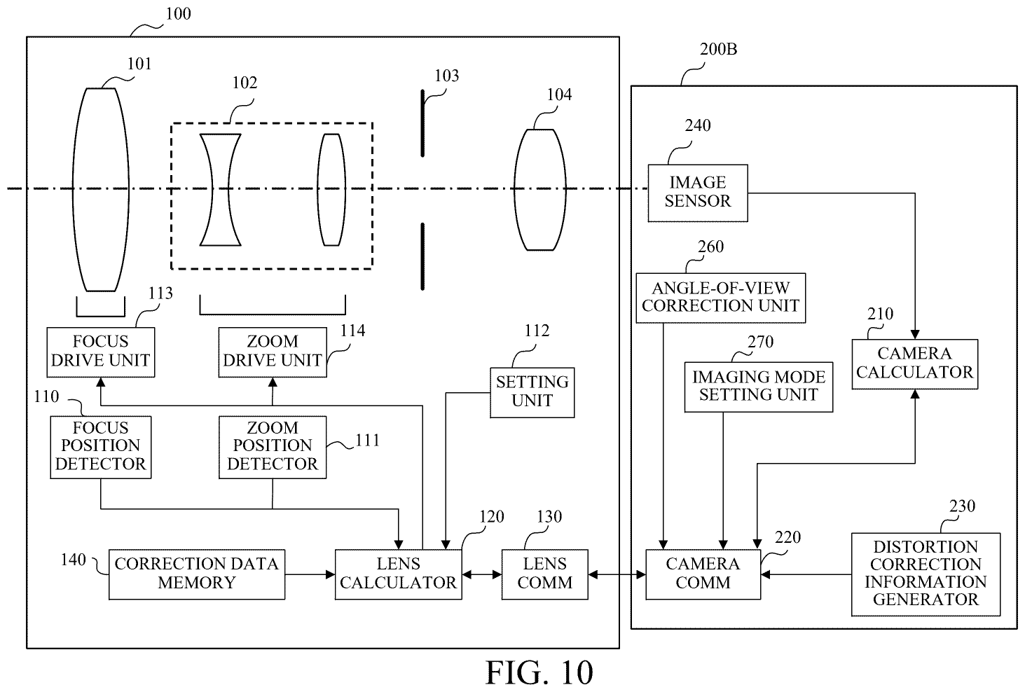

Next, Example 6 will be described. FIG. 10 illustrates the configuration of an imaging system including the interchangeable lens 100 and a digital camera 200B. This example is different from Example 1 in that the digital camera 200B includes an angle-of-view correction unit 260 configured to correct a focus angle-of-view change component in image data by image processing to the image data (referred to as image angle-of-view correction processing hereinafter), and an imaging mode setting unit 270 configured to set an imaging mode. The imaging mode setting unit 270 sets a moving image capturing mode or a still image capturing mode according to the user's operation to the digital camera 200B.

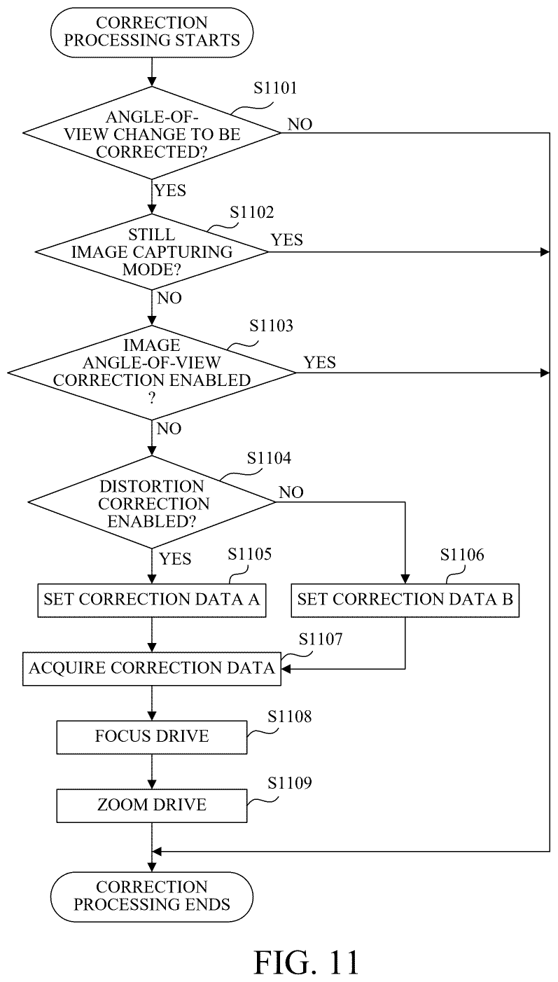

FIG. 11 illustrates lens angle-of-view correction processing executed by the lens calculator 120 according to this example. Step S1101 in FIG. 11 is similar to step S101 in FIG. 1.

In step S1102, the lens calculator 120 determines whether or not the imaging mode set in the digital camera 200B is a still image capturing mode (or a moving image capturing mode), and ends this processing if it is the still image capturing mode. In a case where the imaging mode is a moving image capturing mode, the flow proceeds to step S1103.

In step S1103, the lens calculator 120 determines whether image angle-of-view correction processing is enabled (turned on) or disabled (turned off) in the digital camera 200B. In a case where the image angle-of-view correction processing is enabled, there is no need to correct the focus angle-of-view change in the interchangeable lens 100, and the flow ends. On the other hand, in a case where the image angle-of-view correction processing is disabled, the flow proceeds to step S1104.

Steps S1104 to S1109 are similar to steps S103 to S108 in FIG. 1.

This example corrects the focus angle-of-view change in the interchangeable lens 100 only in a case where the image angle-of-view correction processing in the digital camera 200B is disabled. Then, the correction data for correcting the focus angle-of-view change is switched according to whether the distortion correction processing is performed in the digital camera 200. Thereby, the focus angle-of-view change can be satisfactorily corrected regardless of whether distortion correction processing is performed.

In each example, the focus lens unit 101 disposed closest to an object in the zoom lens may be fixed (not move) during zooming. This configuration can maintain a focal position even if the magnification varying lens unit 102 is moved during zooming, and the roles of focusing and zooming can be independently set for the focus lens unit 101 and the magnification varying lens unit 102. This configuration simplifies the driving structure and driving control in correcting the focus angle-of-view change by driving the magnification varying lens unit 102.

Also, the lens angle-of-view correction processing described in each example may be performed particularly in a case where the focus lens unit disposed closest to an object of the zoom lens has positive refractive power and moves toward the object side during focusing from infinity to a close distance. In this type of zoom lens, the number of lenses constituting the focus lens unit closest to the object can be reduced, which is beneficial to a zoom lens having a reduced size and weight. On the other hand, since there is a large height difference from the optical axis of off-axis rays that pass through at least a part of the focus lens unit between an in-focus state on an object at infinity and an in-focus state on an object at a close distance, the distortion fluctuations due to focusing increases. On the other hand, the lens angle-of-view correction processing according to each example can effectively suppress a focus angle-of-view change regardless of whether the distortion correction processing is enabled or disabled.

### Other Examples

Example(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described example(s) and/or that includes one or more circuits (e.g., application specific integrated circuit (ASIC)) for performing the functions of one or more of the above-described example(s), and by a method performed by the computer of the system or apparatus by, for example, reading out and executing the computer-executable instructions from the storage medium to perform the functions of one or more of the above-described example(s) and/or controlling the one or more circuits to perform the functions of one or more of the above-described example(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

Each example can effectively reduce an angle-of-view change caused by focusing regardless of whether or not aberration correction processing is performed in an image pickup apparatus.

This application claims priority to Japanese Patent Application No. 2024-004407, which was filed on Jan. 16, 2024, and which is hereby incorporated by reference herein in its entirety.

What is claimed is:

1. A lens apparatus attachable to and detachable from an image pickup apparatus, the lens apparatus comprising:
a zoom lens including a focus lens configured to move for focusing, and a magnification varying lens configured to move for magnification variation;
a processor configured to:
perform a lens angle-of-view correction processing for driving the magnification varying lens to reduce an angle-of-view change of the zoom lens associated with movement of the focus lens, and
change the lens angle-of-view correction processing according to whether or not an aberration correction processing for reducing an aberration of the zoom lens is performed for image data in the image pickup apparatus.

2. The lens apparatus according to claim 1, wherein the aberration includes distortion.

3. The lens apparatus according to claim 1, wherein the processor is configured to:
acquire, from the image pickup apparatus, information on whether or not the aberration correction processing is performed, and
change the lens angle-of-view correction processing based on the information.

4. The lens apparatus according to claim 1, further comprising a setting unit configured to enable a user to perform a setting of whether or not the image pickup apparatus performs the aberration correction processing,
wherein the processor is configured to change the lens angle-of-view correction processing according to the setting.

5. The lens apparatus according to claim 1, wherein the processor is configured to change the lens angle-of-view correction processing according to an imaging area in the image pickup apparatus.

6. The lens apparatus according to claim 1, wherein the zoom lens further includes an optical unit configured to change a focal length range of the zoom lens, and insertable into and ejectable from an optical axis of the zoom lens, and
wherein the processor is configured to change the lens angle-of-view correction processing according to whether the optical unit is inserted or ejected.

7. The lens apparatus according to claim 1, wherein the processor is configured to:
perform the lens angle-of-view correction processing using correction data for driving the magnification varying lens, and
change the correction data according to whether or not the aberration correction processing is performed in the image pickup apparatus.

8. The lens apparatus according to claim 7, further comprising a memory storing the correction data that is used in a case where the aberration correction processing is performed in the image pickup apparatus and the correction data that is used in a case where the aberration correction processing is not performed in the image pickup apparatus.

9. The lens apparatus according to claim 7, further comprising a memory storing first data as the correction data that is used for one of a case where the aberration correction processing is performed in the image pickup apparatus and a case where the aberration correction processing is not performed in the image pickup apparatus, and second data for generating the correction data that is used in another case by combining the first data.

10. The lens apparatus according to claim 9, wherein the second data has a data capacity smaller than that of the first data.

11. The lens apparatus according to claim 1, wherein in a case where the image pickup apparatus can perform an image angle-of-view correction processing for correcting the angle-of-view change for the image data, the processor is configured to perform the lens angle-of-view correction processing only in a case where the image angle-of-view correction processing is not performed in the image pickup apparatus.

12. The lens apparatus according to claim 1, wherein in a case where the image pickup apparatus can capture a still image and a moving image, the processor is configured to perform the lens angle-of-view correction processing only while the moving image is being captured by the image pickup apparatus.

13. The lens apparatus according to claim 1, wherein the zoom lens includes the focus lens in a lens unit disposed closest to an object.

14. The lens apparatus according to claim 13, wherein the lens unit disposed closest to the object has positive refractive power, and the focus lens moves toward an object side during focusing from infinity to a close distance.

15. An image pickup apparatus to which the lens apparatus according to claim 1 is detachably attachable, and in which the aberration correction processing can be set to be enabled or disabled.

16. A control method for a lens apparatus that is attachable to and detachable from an image pickup apparatus and includes a zoom lens including a focus lens configured to move for focusing and a magnification varying lens configured to move for magnification variation, the control method comprising:
performing a lens angle-of-view correction processing for driving the magnification varying lens to reduce an angle-of-view change of the zoom lens associated with movement of the focus lens, and
changing the lens angle-of-view correction processing according to whether or not an aberration correction processing for reducing an aberration of the zoom lens is performed for image data in the image pickup apparatus.

17. A non-transitory computer-readable storage medium storing a program that causes a computer to execute the control method according to claim 16.
